(19) United States
(12) Patent Application Publication
(10) Pub. No.: US 2025/0047711 A1
(43) Pub. Date: Feb. 6, 2025

(54) DIGITAL SECURITY PLATFORM FOR ELEVATING COMPUTING DEVICE SECURITY CHALLENGES FOR NETWORK EVENTS

(71) Applicant: Chime Financial, Inc., San Francisco, CA (US)

(72) Inventors: Varun Rai, Milpitas, CA (US); Lace Cheung, San Francisco, CA (US); Jeremy Steinberg, Chicago, IL (US); Ryan Bahniuk, Chicago, IL (US); Charles Kirk, Chicago, IL (US); Dain Hall, Chicago, IL (US); Jocelyn Takahashi, San Francisco, CA (US); Joe Levering, Chicago, IL (US); Kevin Shu, Chicago, IL (US)

(21) Appl. No.: 18/363,312

(22) Filed: Aug. 1, 2023

(51) Int. Cl. H04L 9/40

(52) U.S. Cl. CPC H04L 63/20; H04L 63/08

(57) ABSTRACT

This disclosure describes a security elevation system that, as part of an inter-network facilitation system, can generate elevated security challenges adapted to requested network events using a security challenge platform that is agnostic to challenge type, vendor network, and network event. For example, the disclosed systems can utilize the security challenge platform to generate and distribute elevated security challenges for network events that warrant elevated client device interaction (e.g., beyond initial login interactions or other interactions). In some cases, the disclosed systems can utilize a logic platform to determine whether a network event warrants or necessitates elevated security considerations (e.g., for network events that transmit sensitive data) and can further utilize a security challenge platform to generate and provide a corresponding elevated security challenge specific to the network event.

### BACKGROUND

Recent years have seen significant developments in systems that utilize distributed computing resources to process large data volumes in generating and managing digital accounts and network events across computer networks. For example, conventional networking systems utilize a variety of computing devices in distributed network architectures to manage and track network data, including network events requesting login permissions and/or requesting transfer of data from one digital account to another. To illustrate, conventional systems often employ computer algorithms to authenticate credentials for user accounts requesting various network events, such as login events or data transfer events. Although conventional systems utilize various computer-implemented algorithms to authenticate network events, conventional systems nevertheless suffer from a number of technical deficiencies, particularly with regard to data security, flexibility, and network efficiency.

As just suggested, some existing networking systems are insecure. To elaborate, some existing systems are vulnerable to attacks from malicious actors seeking to corrupt network data through fraudulent network events. While many systems do employ security measures, such as login credentials and multi-factor authentication, even these systems are susceptible to data loss or corruption, especially in cases where security vendors are experiencing network difficulties or crashes. Indeed, some existing systems rely on a single vendor and/or a single challenge type when implementing multi-factor authentication. Without the ability to adaptively pivot to different vendors and/or different challenge types on a per-event basis, such existing systems risk data exposure and network event failure, resulting not only in data security issues but also in poor system reliability.

As suggested, some prior network systems are also inflexible. Indeed, as just suggested, existing systems often employ a one-size-fits-all approach to data security for network events. For example, existing systems often utilize the same challenge type from the same vendor for each network event that warrants elevated or additional authentication. In addition, the one-size-fits-all approach of some existing systems extends to device compatibility as well, where some systems treat all devices equally (sometimes differentiating between mobile and non-mobile devices) when distributing security challenges, regardless of individual device capabilities. As a further example of their inflexibilities, in cases where the network of a challenge vendor is undergoing maintenance or is otherwise experiencing slowdowns or network difficulty, some existing systems simply generate errors and/or wait to re-establish communication with the vendor. As a contributing factor to this inflexibility, the architectures of some existing systems utilize rigid programming paradigms where security measures are built directly into network components that perform network transactions, making adaptation to updates and changes to security protocols difficult if not impossible.

Due at least in part to their inflexible natures, many conventional networking systems are also inefficient. More specifically, because the architectures of some existing systems build security measures directly into various network components that execute network events, updating such systems requires computationally expensive retooling and reprogramming each of the network components to accommodate updates and changes to security protocols. Indeed, the computational expense of reprogramming large numbers of individual network components across a system can be substantial, especially for systems that accommodate and perform a wide variety of network events.

These, along with additional problems and issues, exist with conventional networking systems.

### SUMMARY

This disclosure describes one or more embodiments of methods, non-transitory computer-readable media, and systems that can solve the foregoing problems in addition to providing other benefits. Particularly, the disclosed systems can improve data security, reliability, flexibility, and efficiency by utilizing a digital security platform that generates and adapts device security challenges on a per-event basis while remaining agnostic to challenge type, vendor network, and network event. For example, the disclosed systems can utilize a security challenge platform to generate and distribute elevated security challenges for network events that warrant elevated client device interaction (e.g., beyond initial login interactions or other interactions). In some cases, the disclosed systems can utilize a logic platform to determine whether a network event warrants or necessitates elevated security considerations (e.g., for network events that transmit sensitive data) and can further utilize a security challenge platform to generate and provide a corresponding elevated security challenge specific to the network event.

### BRIEF DESCRIPTION OF THE DRAWINGS

The detailed description refers to the drawings briefly described below.

FIG. 1 illustrates a block diagram of an environment for implementing an inter-network facilitation system and a security elevation system in accordance with one or more embodiments.

FIG. 2 illustrates an example overview of generating and providing an elevated security challenge in accordance with one or more embodiments.

FIG. 3 illustrates an example diagram of an architecture for a security elevation system in accordance with one or more embodiments.

FIG. 4 illustrates an example diagram of network component distribution and interaction for generating and providing an elevated security challenge in accordance with one or more embodiments.

FIGS. 5A-5C illustrate an example wireline diagram of processes performed by respective network components for a particular event request in accordance with one or more embodiments.

FIG. 6 illustrates an example elevated challenge interface in accordance with one or more embodiments.

FIG. 7 illustrates an example series of acts for generating and providing an elevated security challenge in accordance with one or more embodiments.

FIG. 8 illustrates a block diagram of a computing device for implementing one or more embodiments of the present disclosure.

FIG. 9 illustrates an example environment for an inter-network facilitation system in accordance with one or more embodiments.

### DETAILED DESCRIPTION

This disclosure describes a security elevation system that can securely, flexibly, and efficiently generate and provide elevated security challenges using an adaptable security challenge platform. In some situations, network-based systems perform security analyses for passing information (e.g., network events) among multiple servers which host multiple compartmentalized components, modules, or services (with shared or independent processor(s)) to perform respective functions, where different network components generate and receive different data to perform their respective functions as part of the larger ecosystem. For instance, in response to a request from a client application to log in a particular (type of) digital account within an inter-network facilitation system, the security elevation system can perform a security analysis for the network event defining the login request. Indeed, the security elevation system can utilize logic platform to determine that the event request warrants elevated client device interaction, and the security elevation system can thus utilize a security challenge platform to generate and provide an elevated security challenge.

As just mentioned, the security elevation system can utilize a security challenge platform to generate and provide an elevated security challenge for a network event. For example, the security elevation system utilizes a security challenge platform as an independent network component that is specific to generating and providing security challenges and that is agnostic to (and adaptable to changes in) event types, challenge vendors, and challenge types. Specifically, the security challenge platform can generate an elevated security challenge that prompts additional client device interaction to authenticate execution of a requested network event across a wide array of challenge types (e.g., CAPTCHA, SMS approval, email verification, etc.), the vendor type (e.g., PERSONA, ARKOSE, INCODE, etc.), and/or event types (e.g., login, forgot password, card authorization, etc.).

To generate an elevated security challenge, in some embodiments, the security elevation system analyzes an event request utilizing a logic platform. For instance, the security elevation system utilizes the logic platform to determine a security level or a security category for an event request based on security data associated with the event request. Such security data can include a user account identification, an event type of the requested event, a source account type (and trust level) for a transaction, a destination account type (and trust level) for a transaction, a transaction amount, a time of day when the event request is received, a geographic location of the client device submitting the event request, and other data. From the security data, the security elevation system can utilize the logic platform to determine the security level/category from among a set of levels/categories including: i) approved, ii) denied, or iii) warrants elevation for additional client device interaction.

In certain embodiments, the security elevation system further utilizes a logic platform to analyze a challenge type associated with an event request. For instance, the security elevation system can utilize a logic platform to analyze the event request to determine a corresponding challenge type for the event request and/or to determine a challenge type for an elevated security challenge corresponding to the event request. Indeed, the security data of different event requests can correspond to, or lead to a selection of, different challenge types and/or different vendors. In some cases, the security elevation system utilizes a logic platform to analyze a challenge vendor associated with an event request. For example, the security elevation system analyzes (via the logic platform) the security data of an event request and/or a selected challenge type for the event request to identify and select a vendor network that provides the selected challenge type for the event request. The logic platform can further select fallback vendors and/or alternative elevated security challenges based on network availability of challenge vendor networks.

In one or more embodiments, the security elevation system further utilizes a security challenge platform to generate and provide an elevated security challenge. More specifically, the security elevation system can determine, using a logic platform, that an event request warrants elevation for additional client device interaction, and, based on such a determination, can utilize a security challenge platform to generate a corresponding elevated security challenge. Indeed, the security elevation system can access an application programming interface (API) for a challenge vendor network selected for the event request and can generate an elevated security challenge for the event request. In some cases, the security elevation system can redirect a client device away from an ordinary event workflow for interacting with an inter-network facilitation system to a security challenge workflow managed by the security challenge platform. Upon completion of the elevated security challenge via the security challenge workflow, the security elevation system can return the network communications of the client device to the original event workflow.

As suggested above, the disclosed security elevation system provides several improvements or advantages over conventional networking systems. For example, the security elevation system can improve data security and network reliability over prior systems. As opposed to prior systems that sometimes experience network event failures and/or data loss when their sole vendor experiences network difficulties, the security elevation system can select fallback vendors and/or alternative challenge types based on vendor network availability. Specifically, by utilizing a logic platform that analyzes security data of an event request, and that monitors network availability of challenge vendors on a per-event basis, the security elevation system can select fallback vendors and/or alternative elevated security challenges specific to event requests. Thus, unlike prior systems that sometimes fail to provide security challenges and therefore risk data exposure, the security elevation system utilizes a robust multi-vendor approach to ensure fallback vendors and security challenges, even when some vendor networks are unavailable.

As a further example of improved network reliability, the security elevation system can prevent or avoid the bottlenecks experienced by some prior systems by using an independent, asynchronous, stateless security challenge platform. Compared to prior systems that include security measures coded into synchronous network components for executing network events, the security elevation system isolates the security challenge programming into a stateless security challenge platform that transmits and receives data (e.g., to and from a logic platform and/or other network components) in an asynchronous fashion. Thus, whereas a failed synchronous data call in a prior system can cause network crashes or severe communication bottlenecks (and/or error messages and poor responsiveness disrupting normal interface workflows) by inhibiting subsequent network processes that rely on the upstream synchronous data call, the security elevation system circumvents such issues by using a stateless security challenge platform that communicates asynchronously. Indeed, by communicating asynchronously within the inter-network facilitation system, the security challenge platform need not wait for other network components to generate, spin up, and provide data in any particular sequence and/or based on any particular timing restrictions, thus facilitating faster (e.g., immediate), more reliable distribution of data for elevated security challenges upon receipt of an elevated decision from a logic platform.

In addition to the improved security and reliability, the security elevation system can provide improved flexibility over prior networking systems. For example, some prior systems are rigidly fixed to a one-size-fits-all approach to security challenges. The security elevation system, by contrast, can utilize a logic platform to select different elevated security challenges for different event requests, depending on the security data associated with the event requests. In addition, the security elevation system can adapt the selection of security challenges to the capabilities of individual client devices (e.g., to provide one challenge type to less capable legacy devices and another challenge type to newer devices with stronger processors, more memory, and/or better network connectivity). Further, the security elevation system can flexibly adapt security challenges and vendors based on vendor network availability, unlike prior systems that may simply generate errors or result in long wait times.

Due at least in part to the improved flexibility of the security elevation system, the security elevation system can also improve computational efficiency over existing networking systems. While some existing network systems are prone to expensive reprogramming across many network components and software platforms for each security protocol upgrade or change, the security elevation system utilizes a compartmentalized security challenge platform that handles security challenges independently of other platforms within various event workflows. Accordingly, the security elevation system need only update the security challenge platform for security protocol changes, thus saving significant computational resources such as processing power and memory compared to the reprogramming process of prior systems. These computational savings are especially pronounced in systems with many network components and software platforms that handle large varieties of network events and manage large numbers of user accounts.

As indicated by the foregoing discussion, the present disclosure utilizes a variety of terms to describe features and advantages of the security elevation system. For example, as used herein, the term “inter-network facilitation system” refers to a system that, via the security elevation system, facilitates digital communications across different computing systems over one or more networks. For example, an inter-network facilitation system manages digital accounts, such as credit accounts, bank accounts, transaction card accounts, and secured accounts in addition to financial information, such as funds transfers, withdrawals, deposits, and loans for one or more user profiles registered within the inter-network facilitation system. In some cases, the inter-network facilitation system is a centralized network system that includes multiple network components for facilitating access to online digital accounts via a central network location. Indeed, the inter-network facilitation system can link accounts from different network-based financial institutions to provide information regarding, and management tools for, the different accounts.

Additionally, the term “network component” (or sometimes simply “component”) refers to a computer application or subsystem operated by one or more processors (hosted by one or more servers) that are dedicated to a particular computer task or process. For example, a network component can be part of a larger network-based system and can be communicatively coupled (e.g., via a computer network) to other network components for passing data therebetween to form a networking environment of cooperating network components. A network component can perform one or more tasks associated with one or more applications (e.g., client device applications) that access an inter-network facilitation system. Thus, an inter-network facilitation system can include multiple (containerized) network components that each perform respective functions as subsystems within the system. In certain embodiments, a network component refers to a server running a specific process. In some cases, one network component receives event requests received from another network component, while yet another network component generates a digital payload for the received request. Example network components can include a security challenge platform that generates elevated security challenges, a logic platform that determines elevation status and security data for event requests, an API gateway service (e.g., Graph Query Language or “GraphQL”) that proxies event requests and other communications between client devices and network components, an event creation service that generates or creates network events based on event requests, and an event execution service that executes or performs network events for event requests.

As mentioned, in some embodiments, the security elevation system can manage and distribute network events. As used herein, a “network event” (or simply “event”) refers to a discretized portion of network data (e.g., a digital payload) that represents or codifies an occurrence with a computer system or a computer network. For example, a network event can include an immutable segment of computer code that represents a network transaction, such as a transfer of assets from one digital account to another, a deposit into a digital account, a withdrawal from a digital account, a credit check on a digital account, a purchase made by a digital account, or some other recordable occurrence within an inter-network facilitation system. A network event can include computer code representing client device interactions, such as clicks, views, or scrolls or can include computer code representing other computer system events such as network traffic information, login events, crash events, or slowdown events. A network event can include code defining various attributes or parameters associated with a network transaction, including security data defining a user account identification for a user account requesting the network event, an event type of a network event, a transaction amount of a network event, data transmitted for a network event, a time of day when an event request is received for a network event, a geographic location of the client device submitting an event request for a network event, an account type to be accessed via a network event, or a communication type of a communication to be transmitted via a network event.

In addition, as used herein, the term “logic platform” refers to a network component that analyzes network events and/or event requests to make determinations regarding security challenges, vendors, and/or security categories/levels. For example, a logic platform can refer to a no-code network component that, based on defined operational parameters (e.g., provided via a logic platform definition interface), extracts and processes security data for an event request or a network event. Based on the security data, the logic platform further determines whether the event warrants elevation for additional client device interaction to authenticate the event request (e.g., based on data sensitivity). In addition, the logic platform determines a vendor and/or a challenge type for a network event based on the security data. In some cases, the logic platform generates an encrypted logic string that encodes data for a selected security challenge and/or a selected vendor (along with other data) for generating an elevated security challenge.

As further used herein, the term “security challenge platform” refers to a network component that generates and manages a security challenge (e.g., an elevated security challenge). For example, a security challenge platform processes data from a logic platform (e.g., an encrypted data string) to determine or identify a vendor network and/or a challenge type for an elevated security challenge. The security challenge platform further generates the elevated security challenge for distribution to a client device. For instance, the security challenge platform generates a customized elevated security challenge specific to an event request based on data within an encrypted logic string that indicates a user account identification, a challenge type, a vendor, and a network event identification.

Relatedly, as used herein, the term “security challenge” refers to computer code that prompts or requires client device interaction as part of an authentication or verification process. For example, a security challenge can have a particular “challenge type” that defines a specific tool or a specific digital format for a security challenge. Example challenge types include: i) SMS multi-factor authorization via a mobile device that provides a verification code (having a lifespan or an expiration) within a text message to a mobile device, ii) SMS/phone multi-factor authorization that provides an option for either text or phone call delivery of a verification code, iii) email verification that provides a selectable verification link to an email address, iv) scan ID that requests use of a client application to capture a first image of a user and a second image of a user's ID card for comparison, v) document upload that requires upload of the first and second images from scan ID for manual approval by a security agent, vi) SMS approval that requests a text message from a client device indicating approval, vii) CAPTCHA that prompts completion of a visual puzzle or challenge (not for specific identities, only for bot prevention), and/or viii) 3-D Secure (“3DS”) that provides a verification code (having a lifespan or an expiration) within a text message or an email to a mobile device and that uses the verification code (or responses to security questions or confirmation of a social security number or a credit card number) to verify ownership of a phone number within a particular computer network (e.g., the network of an issuing bank).

In addition, a security challenge can correspond to a particular “security category” or “security level” that defines or indicates a level or magnitude of risk associated with a network event or an event request. For example, a logic platform determines a security category/level based on security data for an event, where the security category/level corresponds to a level of risk and/or trustworthiness of an event request based on the security data (e.g., based on user identification, a transfer amount, a source account for the event, a target account for the event, etc.). Example security categories/levels include: i) approved, ii) denied, or iii) warrants elevation for additional client device interaction. Along these lines, an “elevated security challenge” refers to a security challenge that requires additional client device interaction beyond a baseline level for performing a network event. In some cases, an elevated security challenge is additive on top of an initial security challenge, while in other cases an elevated security challenge is a replacement for an initial security challenge based on a logic platform determination.

As used herein, the term “security data” refers to computer data defining parameters of an event request and/or a network event that impact or affect its security determination. For example, security data includes data that a logic platform processes to determine a security category associated with an event request based on the trustworthiness or risk associated with a requested network event. Security data can include a user account identification, an event type of the requested event, an event identification for a specific network event or event request, a source account type (and trust level) for a transaction, a destination account type (and trust level) for a transaction, a transaction amount, a time of day when the event request is received, a geographic location of the client device submitting the event request, and other data.

In addition, as used herein, the term “challenge vendor network” (or “vendor network” or “challenge vendor” or “vendor”) refers to a network that hosts and provides security challenges. For example, a challenge vendor makes an API available to other systems for accessing and utilizing computer code segments generated for implementing security challenges. In some cases, a challenge vendor network is external to the inter-network facilitation system and provides challenge-specific computer code segments for implementation by the security elevation system upon request. Example vendor networks include TWILIO, INCODE, ARKOSE, BRAZE, MAILGUN, S3, CARDINAL, and PERSONA.

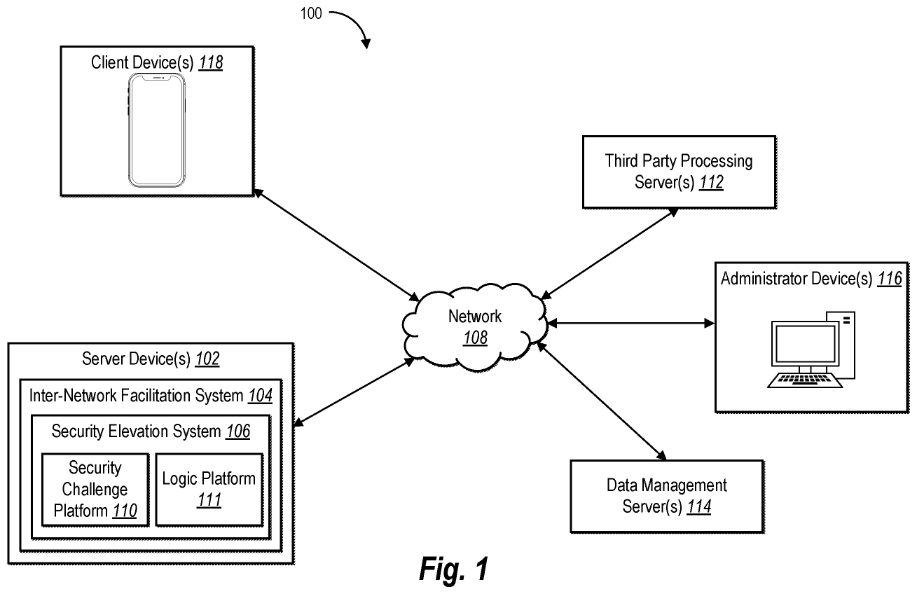

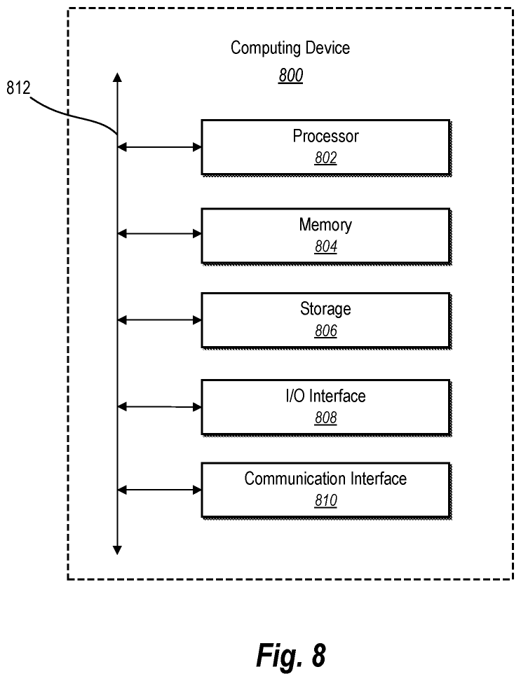

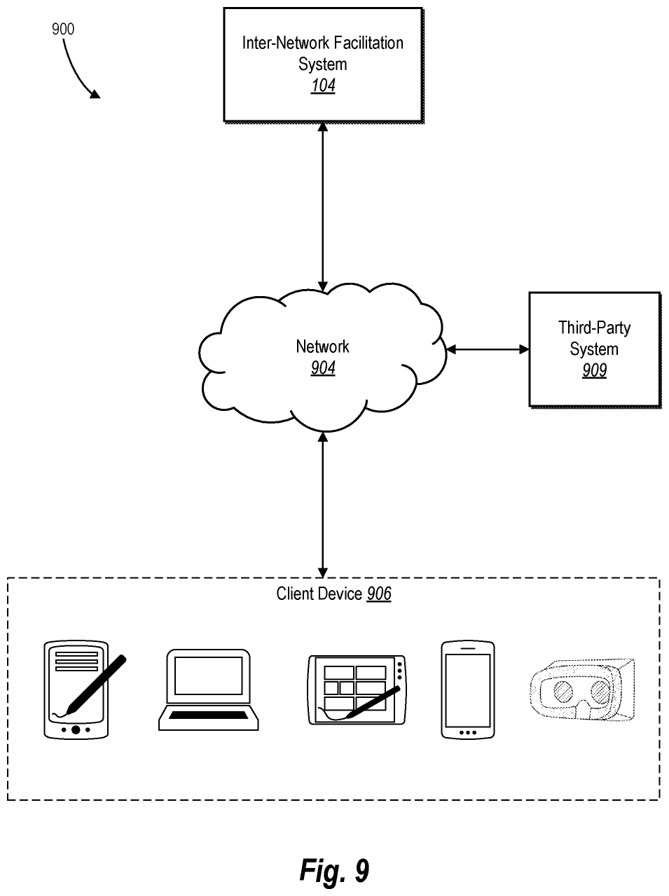

Additional detail regarding the security elevation system will now be provided with reference to the figures. In particular, FIG. 1 illustrates a block diagram of a system environment (or “environment”) 100 for implementing an inter-network facilitation system 104 and a security elevation system 106 in accordance with one or more embodiments. As shown in FIG. 1, the environment 100 includes server device(s) 102, third-party processing server(s) 112, data management server(s) 114, administrator device(s) 116, and client device(s) 118 connected via a network 108. While FIG. 1 shows an embodiment of the security elevation system 106, alternative embodiments and configurations are possible. Furthermore, although FIG. 1 illustrates the security elevation system 106 being implemented by a particular component and/or device within the environment 100, the security elevation system 106 can be implemented, in whole or in part, by other computing devices and/or components in the environment 100 (e.g., the administrator device(s) 116 and/or the client device(s) 118). Additional description regarding the illustrated computing devices is provided with respect to FIGS. 8-9 below.

As shown in FIG. 1, the server device(s) 102 can include the inter-network facilitation system 104. In some embodiments, the inter-network facilitation system 104 determines, stores, generates, and/or displays financial information corresponding to a digital account (e.g., a banking application, a money transfer application). Furthermore, the inter-network facilitation system 104 can electronically communicate (or facilitate) financial transactions between one or more digital accounts (and/or computing devices). In some embodiments, the inter-network facilitation system 104 also tracks and/or monitors financial transactions and/or financial transaction behaviors of a user within a user profile.

Indeed, in some examples, the inter-network facilitation system 104 facilitates financial transactions and digital communications across different computing systems and/or network components over one or more transaction computer networks. Indeed, in some cases, the environment 100 also includes transaction computer network devices (or “transaction computer networks”). The transaction computer network devices can include a variety of computer devices for implementing, facilitating, processing, or executing a transaction. Thus, for instance, the transaction computer network devices can include a card transaction computer network for implementing a variety of transactions using cards (e.g., credit cards, debit cards, etc.). Similarly, the transaction computer network devices can include an ACH transaction computer network (e.g., computing devices for implementing ACH transactions), and the transaction computer network devices can include a transfer transaction computer network (e.g., computing devices for implementing transfer transactions between accounts).

For example, the inter-network facilitation system 104 manages digital accounts, such as credit accounts, secured accounts, and other accounts for a single account registered within the inter-network facilitation system 104. In some cases, the inter-network facilitation system 104 is a centralized network system that facilitates access to online banking accounts, credit accounts, and other accounts within a central network location. Indeed, the inter-network facilitation system 104 can link accounts from different network-based financial institutions (e.g., transaction computer network devices) to provide information regarding, and management tools for, the different accounts. Furthermore, the security elevation system 106 can provide various user interfaces and information for display (e.g., via the administrator device(s) 116 and/or the client device(s) 118).

As also illustrated in FIG. 1, the environment 100 includes the administrator device(s) 116 and the client device(s) 118. For example, the administrator device(s) 116 and the client device(s) 118 may include, but are not limited to, a mobile device (e.g., smartphone, tablet) or other type of computing device, including those explained below with reference to FIGS. 8-9. For example, the administrator device(s) 116 can include computing devices that display user interfaces for administrating or managing settings, configurations, pipelines, or data for the inter-network facilitation system 104. Moreover, the client device(s) 118 can include computing devices associated with (and/or operated by) users and corresponding user profiles for the inter-network facilitation system 104. In some embodiments, the client device(s) 118 include computing devices that display user interfaces for managing digital accounts and/or network events (e.g., transferring assets, making payments, etc.) and/or portraying information regarding digital accounts (e.g., account transactions, account balances, etc.). Moreover, although FIG. 1 illustrates a single instance of the administrator device(s) 116 and the client device(s) 118, the environment 100 can include various numbers of administrator or client devices that communicate and/or interact with the inter-network facilitation system 104 and/or the security elevation system 106.

In one or more embodiments, the client device(s) 118 include a client application. The client application can include instructions that (upon execution) cause the client device(s) 118 to perform various actions. For example, a user associated with an account can interact with the client application on the client device(s) 118 to perform a network event, such as accessing financial information, initiating a financial transaction, or modifying account settings. In some embodiments, the administrator device(s) 116 also includes an administrator application similar to the client application. The client application may be a web application or a native application (e.g., a mobile application, a desktop application, etc.). In one or more implementations, the client application interfaces with the inter-network facilitation system 104 to provide digital content including graphical user interfaces to the client device(s) 118. In one or more implementations, the client application comprises a browser that renders graphical user interfaces on the display of the client device(s) 118.

In certain instances, the client device(s) 118 corresponds to one or more user accounts (e.g., user accounts stored at the server device(s) 102). For instance, a user of a client device can establish a user profile with login credentials and various information corresponding to the user. In addition, the digital accounts and/or user profiles can include information regarding financial information and/or financial transaction information for users (e.g., name, telephone number, address, bank account number, credit amount, debt amount, financial asset amount), payment information, transaction history information, and/or contacts for financial transactions. In some embodiments, a digital account and/or a user profile can be accessed via multiple devices (e.g., multiple client devices) when authorized and authenticated.

The present disclosure utilizes client devices to refer to devices associated with such user profiles. In referring to a client device, the disclosure and the claims are not limited to communications with a specific device, but any device corresponding to a user profile of a particular user. Accordingly, in using the term computing device, this disclosure can refer to any computing device corresponding to a user profile of an inter-network facilitation system.

As shown, the environment 100 also includes third-party processing server(s) 112. For example, in one or more embodiments, the inter-network facilitation system 104 utilizes the third-party processing server(s) 112 to assist in processing transactions (e.g., managing a system of record, transferring funds between accounts, implementing transaction pipelines, etc.). In some cases, the third-party processing server(s) 112 house and operate third-party systems, such as machine learning servers, event databases, and/or other network components that consume or utilize network event data. The third-party processing server(s) 112 can include a variety of server devices, as described below in relation to FIGS. 8-9.

Furthermore, as illustrated in FIG. 1, the environment 100 also includes data management server(s) 114. The data management server(s) 114 can include integrated or external (e.g., third-party) servers for storing, analyzing, and managing data volumes. For example, the data management server(s) 114 can include a variety of cloud/web-based systems for storing, processing, analyzing, and delivering transaction data, event data, and/or account data. The data management server(s) 114 can include a variety of server devices, as described in relation to FIGS. 8-9.

As further shown in FIG. 1, the environment 100 includes the network 108. As mentioned above, the network 108 can enable communication between components of the environment 100. In one or more embodiments, the network 108 may include a suitable network and may communicate using a various number of communication platforms and technologies suitable for transmitting data and/or communication signals, examples of which are described with reference to FIGS. 8-9. Furthermore, although FIG. 1 illustrates the server device(s) 102, the third-party processing server(s) 112, the data management server(s) 114, and the administrator device(s) 116 communicating via the network 108, the various components of the environment 100 can communicate and/or interact via other methods (e.g., the server device(s) 102 and the administrator device(s) 116 can communicate directly).

As illustrated in FIG. 1, the security elevation system 106 includes a security challenge platform 110 and a logic platform 111. In particular, the security elevation system 106 can include a security challenge platform 110 and a logic platform 111 as network components within the inter-network facilitation system 104 of distributed network components. In some embodiments, the security challenge platform 110 includes a number of network components (housed on the server device(s) 102 or elsewhere in the environment 100) that work together to generate and provide elevated security challenges for event requests. In these or other embodiments, the logic platform includes a number of network components (housed on the server device(s) 102 or elsewhere in the environment 100) that work together to determine security categories, security data, vendors, security challenges, and/or challenge types for event requests.

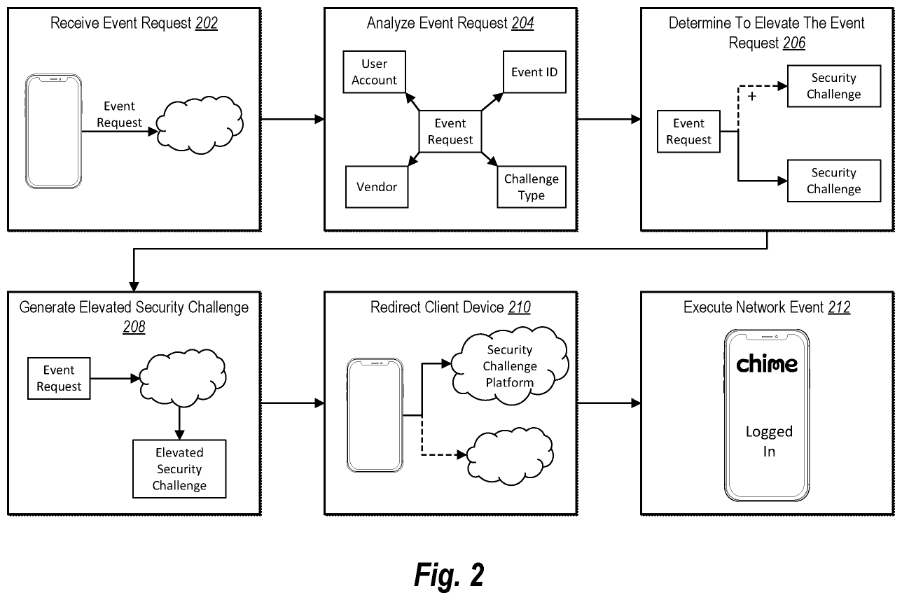

As mentioned, in certain embodiments, the security elevation system 106 can generate and provided an elevated security challenge to a client device. In particular, based on an event request received from the client device, the security elevation system 106 can utilize a logic platform to determine that elevated treatment is warranted (e.g., necessary, required, or preferred for security purposes) and can utilize a security challenge platform to generate an elevated security challenge. FIG. 2 illustrates an example overview of generating and providing an elevated security challenge in accordance with one or more embodiments. Additional detail regarding the acts of FIG. 2 is provided thereafter with reference to subsequent figures.

As illustrated in FIG. 2, the security elevation system 106 performs an act 202 to receive an event request. In particular, the security elevation system 106 receives an event request from a client device, where the event request defines a network event, such as a login event, a transaction event, a profile information update event, a re-establishment event for re-establishing a suspended user account, a communication event, or an account access event. Indeed, the security elevation system 106 receives the event request in the form of computer code defining event parameters and security data for the network event. Some user accounts or account types may require additional security measures beyond those required by other account types, and certain network events (e.g., transactions of larger amounts, transactions for less trusted accounts, or re-establishment of suspended accounts) may also require further security measures than other network events.

Accordingly, as further illustrated in FIG. 2, the security elevation system 106 performs an act 204 to analyze the event request. In particular, the security elevation system 106 analyzes the event request to determine security data associated with a requested network event. For example, the security elevation system 106 utilizes a logic platform to analyze the event request (and/or the network event indicated by the event request) to determine security data for the event request as part of determining whether to elevate the event request for further client device interaction. As shown, the security elevation system 106 determines a user account identification, an event identification, a vendor identification, and a challenge type indicated by the event request.

As further illustrated in FIG. 2, the security elevation system 106 performs an act 206 to determine to elevate the event request. More specifically, the security elevation system 106 utilizes a logic platform to generate an elevation decision based on the security data of the event request (or the requested network event). For instance, the security elevation system 106 determines that a login event for a particular user account requires additional client device interaction beyond providing login credentials via a login screen. Accordingly, the security elevation system 106 determines to elevate the login event for further client device interaction as part of an elevated security challenge. As shown, the security elevation system 106 determines that an initial security challenge is insufficient for authorizing a requested network event, and the security elevation system 106 thus determines to provide an elevated security challenge (in addition to, or in the alternative to the initial security challenge). In some cases, the security elevation system 106 further utilizes the logic platform to determine a challenge type and vendor network for an elevated security challenge.

Indeed, as shown in FIG. 2, the security elevation system 106 performs an act 208 to generate an elevated security challenge. To elaborate, the security elevation system 106 generates an elevated security challenge by utilizing a security challenge platform to access a vendor network to retrieve a particular challenge type indicated by a logic platform. For example, the security elevation system 106 accesses a vendor network that provides a particular challenge type that corresponds to a requested network event. If an initial vendor network is unavailable and/or if an initial challenge type is unavailable, the security elevation system 106 accesses a fallback vendor network and/or a fallback challenge type (as determined by a logic platform) to generate the elevated security challenge. Accordingly, the security elevation system 106 generates an elevated security challenge that is specific to a requested network event based on the security data analyzed by the logic platform (e.g., for the particular user account to perform a transaction or some other event).

As further illustrated in FIG. 2, the security elevation system 106 performs an act 210 to redirect a client device. More particularly, the security elevation system 106 redirects the client device that submits an event request. Indeed, the security elevation system 106 utilizes a security challenge platform to redirect network communications of the client device away from an event workflow whereby the client device interacts with the inter-network facilitation system 104 for executing one or more network events. The security elevation system 106 instead redirects the client device to a security challenge workflow for the elevated security challenge curated by the security challenge platform, apart from the normal event workflow. Indeed, the security challenge platform takes over the network communications with the client device until the security challenge is passed, providing user interfaces and processing client device interactions to determine responses to challenge prompts.

In certain embodiments, the security elevation system 106 further maintains an auditable history of security challenges, verifications, and results. For example, the security elevation system 106 monitors and stores (e.g., via the security challenge platform) responses to security prompts across various (elevated) security challenges. The security elevation system 106 further stores indications of passed and failed (elevated) security challenges. Accordingly, the security elevation system 106 generates an auditable (and searchable) database record of security challenges organized by user account, network event, event type, challenge type, and/or vendor.

Once the security elevation system 106 detects that the elevated security challenge is passed, as shown in FIG. 2, the security elevation system 106 performs an act 212 to execute a network event. In particular, the security elevation system 106 executes the requested network event indicated by the event request. For instance, the security elevation system 106 determines that the client device (or the user account associated with the client device) is authorized to perform a requested network event based on the responses to prompts within the elevated security challenge. Accordingly, the security elevation system 106 executes one or more processes to carry out the requested network event.

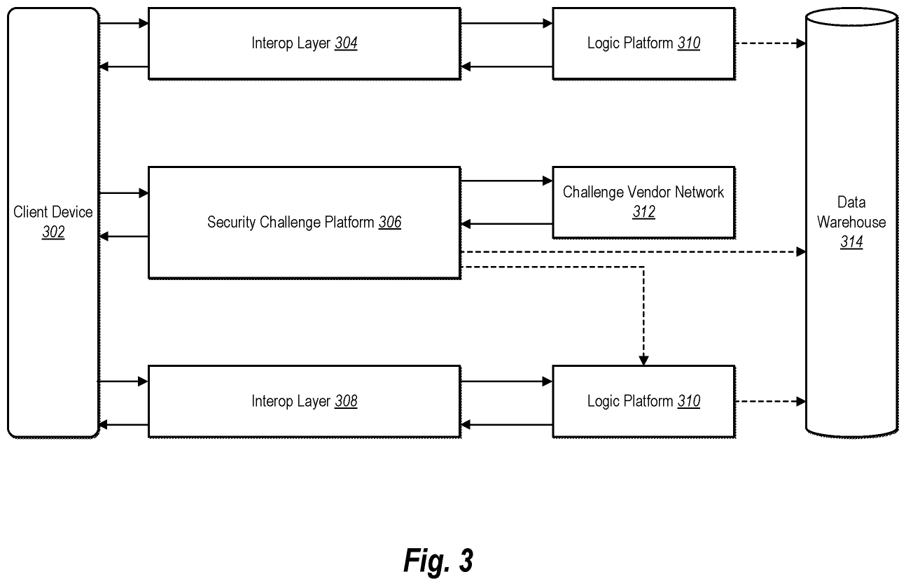

As noted above, in certain described embodiments, the security elevation system 106 uses a logic platform and a security challenge platform to generate and provide an elevated security challenge. In particular, the security elevation system 106 utilizes various network components of the inter-network facilitation system 104 arranged in a particular architecture to generate elevated security challenges in an efficient, adaptable manner without requiring reprogramming of event-focused network components for changes to security protocols or other security updates. FIG. 3 illustrates an example network component architecture of the security elevation system 106 in accordance with one or more embodiments.

As illustrated in FIG. 3, the security elevation system 106 includes a first interoperability layer 304 that communicates with a logic platform 310 and a client device 302. To elaborate, the first interoperability layer 304 receives computer code from the logic platform 310 defining or indicating a decision of whether to elevate a security challenge for an event request. Indeed, as described above, the security elevation system 106 includes a logic platform 310 that determines to elevate a security challenge based on analyzing security data. Indeed, the logic platform 310 can analyze security data for an event request received from the client device 302 and transmitted via the first interoperability layer 304.

For instance, the logic platform 310 can compare the security data with stored security standards within a data warehouse 314 that indicate which combinations of security data corresponding to which security categories/levels. Based on determining the security category for the event request, the logic platform 310 generates computer code encoding such a decision and passes the elevation code to the first interoperability layer 304. In turn, the first interoperability layer 304 communicates with the client device 302 to redirect the network communications of the client device 302 away from an event workflow and into a security challenge workflow.

As also illustrated in FIG. 3, the security elevation system 106 includes a security challenge platform 306 that communicates with challenge vendor networks 312. In particular, the security challenge platform 306 is a stateless network component that has no synchronous dependencies on other network components. The security challenge platform 306 generates and provides an elevated security challenge for display on the client device 302. For example, the security challenge platform 306 generates an elevated security challenge by accessing a security challenge (of a particular challenge type) from a challenge vendor network 312. In some cases, the security challenge platform 306 requests and receives a security challenge from the challenge vendor network 312 as dictated by the logic platform 310 based on the analysis of the security data of an event request. In other cases, the security challenge platform 306 determines the challenge vendor network 312 and the security challenge appropriate for the event request. For instance, the security challenge platform 306 analyzes the security data to determine a trust level for a source account, a trust level for a target account, a transaction amount (and/or other security data) and generates an elevated security challenge accordingly.

As part of the redirected network communications for the client device 302, the security challenge platform 306 communicates with the client device 302 to provide one or more challenge interfaces and to receive client device interactions for challenge prompts within the interfaces. Accordingly, the security challenge platform 306 controls or manages a security challenge workflow for the client device 302 until the client device 302 passes or fails the elevated security challenge. Upon failure, the security challenge platform 306 generates and provides a failure message to the client device 302 and prevents execution of the requested network event. Upon passing, the security challenge platform 306 generates and provides a pass message to the client device 302 and enables execution of the network event.

In some cases, the security challenge platform 306 communicates with the data warehouse 314 to: i) maintain a memory of current security challenges in process, and ii) erase past security challenges that have been completed. In some embodiments, the security challenge platform 306 further passes security challenge results to the logic platform 310 for prevention or enablement of a requested network event. For communications to and from the security challenge platform 306, the security elevation system 106 can utilize a JSON web token (“JWT”) standard to prevent a blocking synchronous call from the integrating service to the security challenge platform 306 (e.g., to prevent the security challenge platform 306 from becoming a single point of failure for every service or network component of the inter-network facilitation system 104). For instance, the security elevation system 106 can utilize the following JWTs:
1) JWT that is the parameter for creating an elevated security challenge:
   Data: decision_id, challenge_type, challenge_request_context, created_at
2) JWT that is the parameter for completing an elevated security challenge:
   Data: id, status, decision_id, challenge_type, challenge_response_context, created_at.

As further illustrated in FIG. 3, the security elevation system 106 includes a second interoperability layer 308. In particular, the second interoperability layer 308 communicates with the logic platform 310 and the client device 302. Specifically, the second interoperability layer 308 provides the context of a result of an elevated security challenge to the logic platform 310. In addition, the second interoperability layer 308 redirects network communications of the client device 302 back to the event workflow for other network components to perform processes to carry out the requested network event. Indeed, the second interoperability layer 308 provides the challenge result to the logic platform 310, whereupon the logic platform 310 can communicate with other network components to execute or carry out a requested network event.

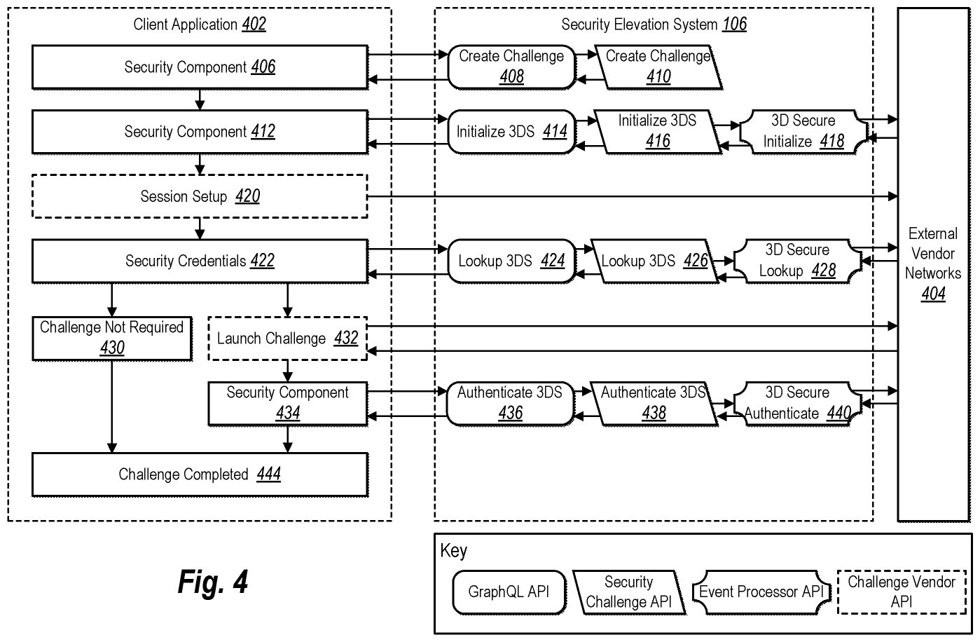

As mentioned above, in certain embodiments, the security elevation system 106 utilizes various network components to generate and provide an elevated security challenge for an event request. In particular, the security elevation system 106 utilizes components that link or call various APIs associated with different network systems to generate and execute an elevated security challenge. FIG. 4 illustrates an example diagram of network component distribution and interaction for generating and providing an elevated security challenge in accordance with one or more embodiments.

As illustrated in FIG. 4, the security elevation system 106 utilizes network components that call functions or processes hosted or maintained by various APIs, such as a GraphQL API that manages communicates between the inter-network facilitation system 104 and client devices, a security challenge API including processes for creating and providing a security challenge, an event processor API including processes for executing a requested network event such as a transaction or a login, and a challenge vendor API including processes for providing a security challenge from a challenge vendor to a client device. In particular, as shown in FIG. 4, the security elevation system 106 performs an act 410 to create an elevated security challenge by calling a security challenge API. In addition, the security elevation system 106 performs an act 408 to generate a creation instruction to provide to the client application 402 utilizing a GraphQL API.

The creation instruction thereby causes the client application 402 to process the elevated security challenge using a security component 406 integrated as part of the client application 402. In addition, the client application 402 utilizes an additional security component 412 (or the security component 406) to initialize rendering or presenting the elevated security challenge. To provide an elevated security challenge for display, the security elevation system 106 accesses external vendor networks 404 to access a particular challenge type from a particular vendor.

Indeed, the security elevation system 106 performs an act 416 to initialize a 3DS challenge utilizing a security challenge API (as determined and selected via a logic platform). For instance, the security elevation system 106 accesses an event processor API for performing an act 418 to identify or determine a 3DS challenge to initialize from the external vendor networks 404. Accordingly, upon identifying and initializing the 3DS challenge, the security elevation system 106 further performs an act 414 to generate initialization code for initializing 3DS on the client application 402 (e.g., utilizing the GraphQL API).

Accordingly, the initialization instructions cause the client application 402 to engage a security component 412 to initialize the 3DS security challenge. Specifically, the initialization instructions redirect the network communications of the client application 402 to the security elevation system 106 for performing a security challenge workflow. As shown, the client application 402 performs a session setup 420 to begin a security challenge process. Indeed, the initialization instructions cause the client application 402 to communicate with the external vendor networks 404 to retrieve or access a particular security challenge of a designated type from an available vendor (or to select a fallback challenge type and/or a fallback vendor depending on network availability and/or device capabilities).

As part of the elevated security challenge, the client application 402 receives or determines security credentials 422. In particular, the client application 402 receives client device interaction responding to one or more prompts included as part of an initial security challenge (e.g., a login page). For example, the security credentials 422 include a user account identification and a password. Based on the client device interactions, the client application 402 determines or extracts the security credentials 422 and provides the security credentials 422 to the security elevation system 106.

In turn, the security elevation system 106 processes the security credentials 422 to determine whether the event request warrants additional client device interaction. Specifically, the security elevation system 106 utilizes a logic platform to determine whether additional client device interaction is warranted. If so, the security elevation system 106 looks up 3DS parameters for an elevated security challenge to provide for further authentication. As shown, the security elevation system 106 performs an act 426 to look up 3DS parameters utilizing a security challenge API and further performs an act 428 to perform 3DS lookup using an event processor API to determine specific challenge parameters for a requested network event. The security elevation system 106 further performs an act 424 to generate a 3DS lookup code to provide to the client application 402, where the 3DS lookup code includes an indication of whether or not to elevate the event request for further client device interaction and/or parameters for an elevated security challenge from a 3DS vendor.

As further illustrated in FIG. 4, the 3DS lookup code causes the client application 402 to either perform an act 430 to avoid launching an elevated security challenge (e.g., if no additional client device interaction is needed for the event request) or to perform an act 432 to launch an elevated security challenge (e.g., if additional client device interaction is needed). Indeed, the client application 402 communicates with the external vendor networks 404 to display or present a 3DS security challenge. In addition, the client application 402 utilizes a security component 434 to monitor or receive client device interaction for the elevated security challenge. For instance, the security component 434 receives data in response to prompts of the elevated security challenge, such as additional credentials, images, account numbers, and other data.

As shown, the security elevation system 106 receives the response data form the security component 434. In addition, the security elevation system 106 processes the response data for the elevated security challenge to determine whether the elevated security challenge is passed or failed. Specifically, the security elevation system 106 performs an act 438 to authenticate the 3DS data provided in response to the elevated security challenge. Indeed, the security elevation system 106 performs an act 438 utilizing a security challenge API and further performs an act 440 to authenticate the 3DS data with the external vendor networks 404 utilizing an event processor API (e.g., for data specific to the event request).

The security elevation system 106 further performs an act 436 to generate an authentication code utilizing a GraphQL API. The security elevation system 106 provides the authentication code to the client application 402, whereupon the client application generates an indication 444 that the elevated security challenge is complete. In some cases, the authentication code further causes the client application 402 to revert back to an event workflow for executing the requested network event, seamlessly transitioning from the security challenge workflow of the security elevation system 106 to the event workflow with other network components.

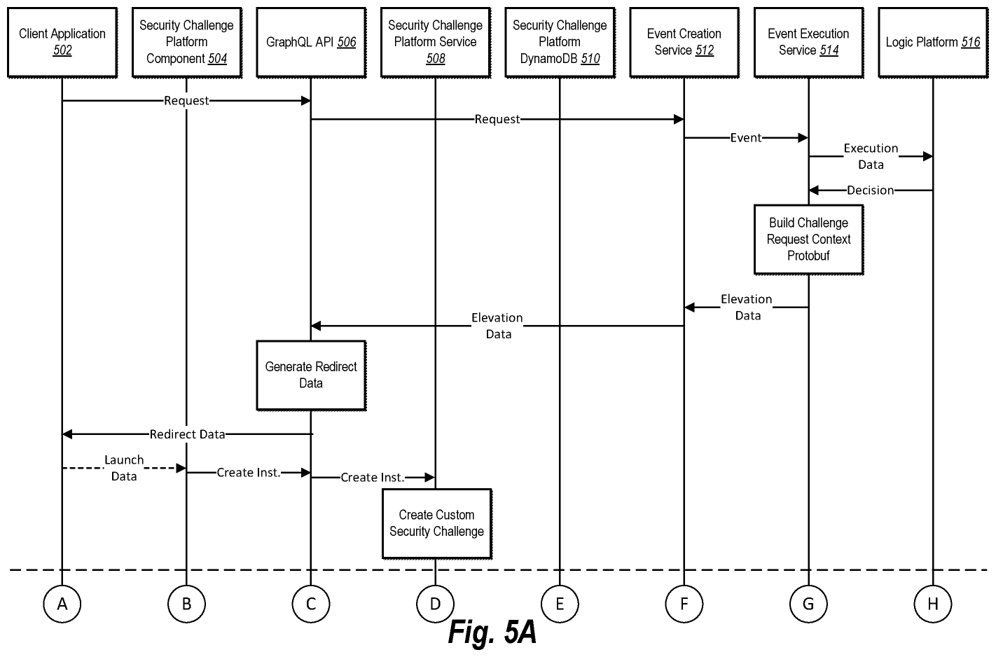

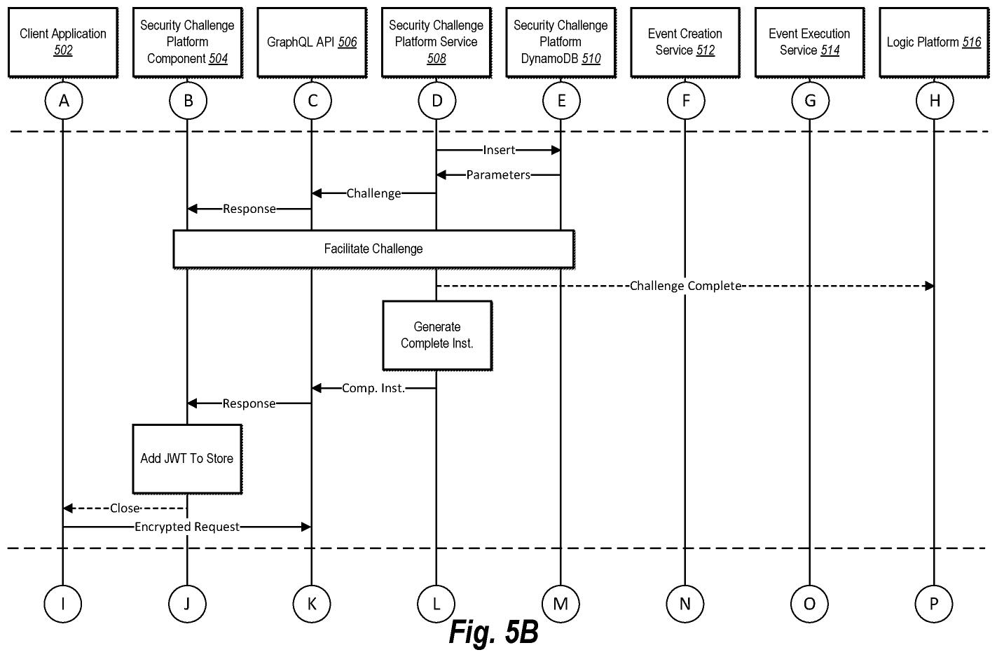

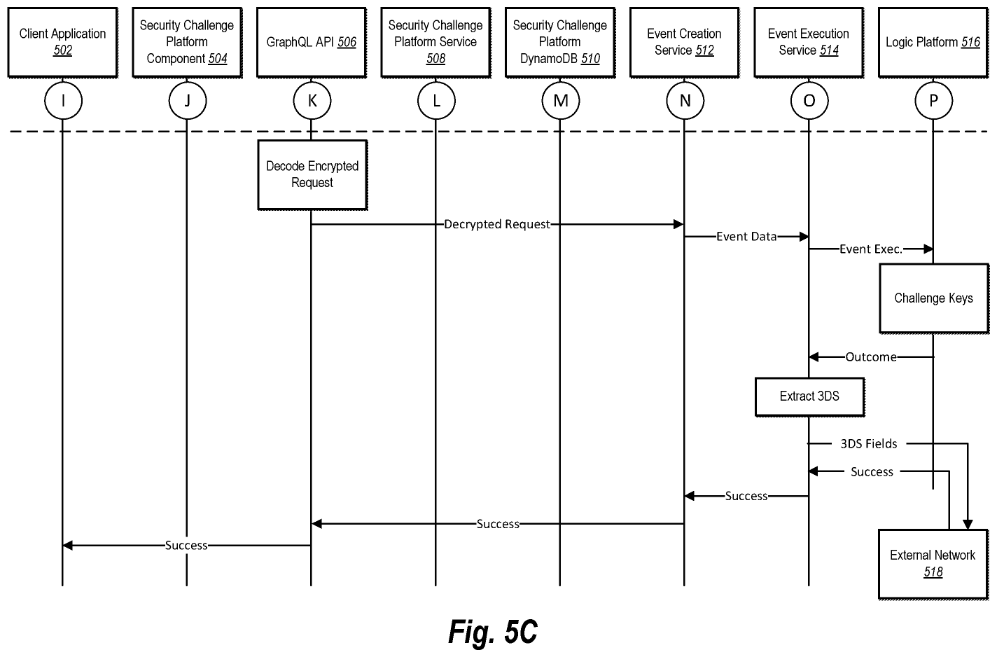

As noted, in certain described embodiments, the security elevation system 106 utilizes various network components to generate an elevated security challenge and to execute a corresponding network event. In particular, the security elevation system 106 utilizes security-specific network components (within a security challenge workflow) to generate and provide a security challenge and further utilizes network components of an event workflow to execute a requested network event upon passing the security challenge. FIGS. 5A-5C illustrate an example wireline diagram of processes performed by respective network components for a particular event request in accordance with one or more embodiments.

As illustrated in FIGS. 5A-5C, the security elevation system 106 includes a number of network components 504-516 for generating and managing an elevated security challenge. For example, the network components 508-516 are located or hosted on one or more servers behind a server firewall, while the client application 502 and security challenge platform component 504 are installed on a client device and the GraphQL API 506 is a server API that communicates between the client device and the network components 508-516 . . . . In some embodiments, the security challenge platform component 504, the security challenge platform service 508, and the security challenge platform DynamoDB are all constituent network components that work together as part of a security challenge platform. Indeed, the network components illustrated in FIGS. 5A-5C work together to generate and execute an elevated security challenge for a particular event request.

To this point, as illustrated in FIG. 5A, the client application 502 generates and provides an event request (“Request”) to a GraphQL API 506 (e.g., an API gateway that manages communicates between the inter-network facilitation system 104 and client devices). For instance, the client application 502 provides an event request to perform a debit transfer of a particular amount from a source account to a target account. Upon receiving the request, the GraphQL API 506 resolves the request and generates a proxy request interpretable by network components of the inter-network facilitation system 104. The GraphQL API 506 further transmits the proxy request to the event creation service 512. In turn, the event creation service generates (computer code defining) a network event (e.g., a TWIRP request) corresponding to the event request and provides the network event to the event execution service 514.

In response to receiving the network event, the event execution service 514 generates execution data to provide to the logic platform 516 to determine whether the network event should be allowed. For example, the event execution service 514 provides execution data that includes security data for the event request along with other information pertaining to the requested network event. In addition, the logic platform 516 analyzes the execution data (including the security data) and generates a decision, such as a security category/level for the event request. For instance, the logic platform 516 determines that the event request is neither allowed nor denied, but warrants additional client device interaction to authorize. As part of the decision, in some cases, the logic platform 516 generates or determines additional data for creating an elevated security challenge, such as a vendor network and/or a challenge type for an elevated security challenge corresponding to the event request. Indeed, the logic platform 516 generates the decision by generating an encrypted logic string that includes execution data for an elevated security challenge specific to the requested network event.

As further illustrated in FIG. 5A, the logic platform 516 passes the decision to the event execution service 514, whereupon the event execution service 514 builds a challenge request context protocol buffer (“protobuf”) that includes a decision identifier and elevated security challenge data for building an elevated security challenge. Indeed, the event execution service 514 generates a protobuf that includes or encodes elevation data for generating an elevated security challenge, where the protobuf is interpretable by other network components. As further shown, the event execution service 514 passes the elevation data to the event creation service 512, indicating to the event creation service 512 that an elevated security challenge is required before execution of the requested network event can be carried out.

In addition, the event creation service 512 passes the elevation data (e.g., the protobuf) to the GraphQL API 506 for translation into data interpretable by the client application 502. Indeed, as shown, the GraphQL API 506 interprets or processes the elevation data protobuf to generate redirect data for providing to the client application 502. More specifically, the GraphQL API 506 generates redirect data in the form of an encrypted JWT and inserts the JWT within the header of a data message interpretable by the client application 502. Accordingly, the GraphQL API 506 provides the redirect data to the client application 502 to redirect network communications of the client application 502 away from a previous event workflow and to instead enter a security challenge workflow for an elevated security challenge.

In response to receiving the redirect data, the client application 402 generates and provides launch data to the security challenge platform component 504. More specifically, the redirect data causes the client application 502 to generate the launch data, including data from the elevation data and causing presentation of one or more challenge interfaces (e.g., a challenge view stack on top of a view stack associated with the network event) that are closable by a user. Upon detect closure, the security challenge platform component 504 prevents execution of the requested network event (e.g., until completion of the elevated security challenge).

As further illustrated in FIG. 5A, the security challenge platform component 504 receives the launch data from the client application 502 and generates a create instruction from the launch data (e.g., including the JWT for the elevation data). The security challenge platform component 504 further passes or transmits the create instruction to the GraphQL API 506, whereupon the GraphQL API 506 proxies or relays the creation instruction to the security challenge platform service 508. In turn, the security challenge platform service 508 utilizes a library or an API of challenge creation processes and functions to create or generate a custom elevated security challenge. Indeed, the security challenge platform service 508 decodes the create instruction (e.g., including the JWT) to extract the context for the challenge request (e.g., a challenge type, a vendor network, an event request identification, and/or other data for the event request), store the context data within the security challenge platform DynamoDB 510, and generate an elevated security challenge according to the create instruction (e.g., of challenge type 3DS from vendor CARDINAL).

To this point, continuing the discussion to FIG. 5B, the security challenge platform service 508 inserts the context data for the elevated security challenge platform within the security challenge platform DynamoDB 510 and accesses the required challenge parameters for the challenge from the security challenge platform DynamoDB 510. As further shown, the security challenge platform service 508 thus generates challenge data that includes the parameters for the elevated security challenge and provides the challenge data to the GraphQL API 506. In response, the GraphQL API 506 generates or maps the challenge data to a response interpretable by front end components, such as the client application 502 and the security challenge platform component 504 (which is installed on a client device in some embodiments).

As further illustrated in FIG. 5B, the security elevation system 106 facilitates the elevated security challenge (“Facilitate Challenge”). To elaborate, the security challenge platform component 504 processes the response from the GraphQL API 506 to launch a user experience for the elevated security challenge. As described, the user experience for the elevated security challenge workflow includes one or more interfaces stacked or overlaid on interfaces of an event workflow, where the interfaces include prompts for additional client device interaction to authorize a requested network event on a type-specific, vendor-specific basis (e.g., to provide digital images, credit card numbers, to select links provided via text message, etc.). In some cases, the security challenge platform service 508 uses 3DS for the challenge type and launches a native CARDINAL SDK to facilitate the challenge workflow, for a back-and-forth with the client application 502. The security challenge platform service 508 can further communicate with the GraphQL API 506 for each received client device interaction and each transmitted challenge prompt for translation to the client application 502.

Upon successful completion of the elevated security challenge, the security challenge platform service 508 further generates a network event indicating that the challenge is complete (e.g., a Hawker event) and provides the completion event to the logic platform 516. In some cases, the completion event includes contextual data, such as the event request identification, the challenge type, the challenge completion status, and/or other information. Upon receiving the completion event, the logic platform 516 generates and writes a completed challenge entry to store for passed challenges.

Additionally, the security challenge platform service 508 generates a complete instruction. For example, the security challenge platform service 508 generates a complete instruction indicating successful completion of the elevated security challenge, where the complete instruction is a JWT that includes contextual data, such as an event request identification, a challenge status, a creation time, a completion time, and/or other information. The security challenge platform service 508 further transmits or provides the complete instruction to the GraphQL API 506, and the GraphQL API 506 generates a response including the new JWT interpretable by front end components.

As shown, the security challenge platform component 504 listens or monitors for the response from the GraphQL API 506 and adds the JWT to a storage location for the client application 502. In addition, the security challenge platform component 504 detects completion of the elevated security challenge based on receipt of the response and thus closes itself and terminates the challenge workflow provided to the client application 502. The security challenge platform component 504 thus reverts the network communications of the client application 502 back to the event workflow for executing the requested network event. As part of the event workflow, the client application 502 resubmits the event request, this time in an encrypted format, where the encryption includes headers or other data indicating successful completion of the elevated security challenge (e.g., to prevent further security challenges for the request).

Looking now to FIG. 5C, the GraphQL API 506 receives the encrypted request and decodes the encrypted request (e.g., the JWT) to verify the authorization of the event request. The GraphQL API 506 thus generates a decrypted request to pass to the event creation service 512 for executed the requested network event. For example, the GraphQL API 506 casts the values of the JWT to a protobuf and adds a stringified version of the protobuf to a request context. In addition, the event creation service 512 processes the decrypted request and, as above, generates event data to provide to the event execution service 514, where the event data includes an event request identification, an event type, security status, and other data.

The event execution service 514, in turn, receives the event data and generates event execution data (including modified security data indicating that the elevated security challenge is successfully completed) to provide to the logic platform 516 to decide whether execution of the requested network event is authorized. Upon receiving the event execution data, the logic platform 516 analyzes the event execution data to determine that the event request is authorized. The logic platform 516 further generates challenge keys to accompany the event request and provides the challenge keys with outcome data indicating that the event request is authorized. The logic platform 516 provides the outcome data to the event execution service 514, and, in response, the event execution service 514 extracts 3DS data (or other challenge type data), such as 3DS fields for enabling the requested network event, from the outcome data.

As further illustrated in FIG. 5C, the event execution service 514 provides the 3DS fields (or other challenge type data) to the logic to an external network 518 for carrying out the requested network event (e.g., to transfer funds from one account to another). The event execution service 514 further receives a success notification from the external network 518 indicating that the requested network event has been successfully executed. In addition, the event execution service 514 further provides or transmits the success notification to the event creation service 512 which forwards the notification to the GraphQL API 506 for translation to the client application 502. Indeed, the GraphQL API 506 provides translated success data to the client application 502 to cause the client application 502 to render or display a success notification for display indicating successful completion of the requested network event.

While FIGS. 5A-5C illustrate an example scenario for a particular event request, the security elevation system 106 can utilizes the illustrated network components to process and facilitate elevated security challenges for other event requests as well. Indeed, the illustrated network components of the security elevation system 106 (e.g., the security challenge platform component 504, the security platform challenge service 508, and the security platform challenge DynamoDB) are agnostic to vendor networks, event types, and challenge types, and are thus adaptable to generate elevated security challenges regardless of the received event request (and/or the vendor network or challenge type selected by the logic platform 516).

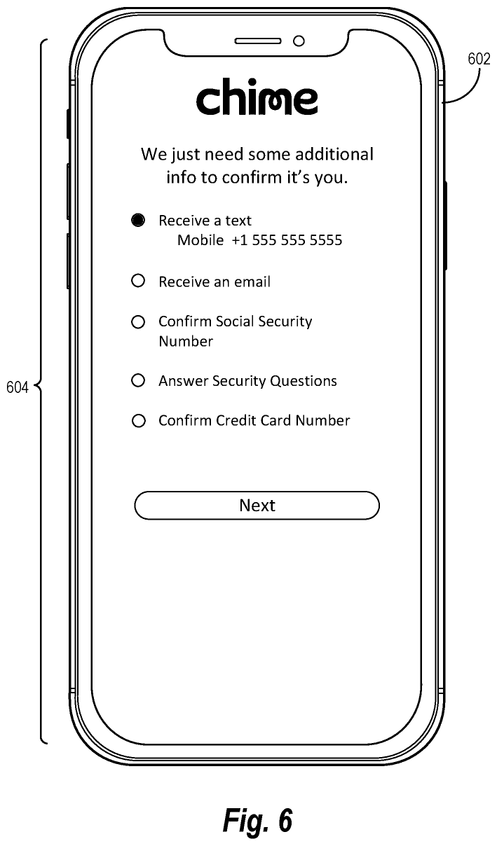

As mentioned above, in certain described embodiments, the security elevation system 106 generates and provides an elevated security challenge for display on a client device. In particular, the security elevation system 106 provides a challenge workflow that overlays or stacks on an event workflow on a client device. FIG. 6 illustrates an example elevated challenge interface in accordance with one or more embodiments.

As illustrated in FIG. 6, the client device 602 presents or displays an elevated challenge interface 604 that includes interface elements for an elevated security challenge. For example, the elevated challenge interface 604 includes interface elements for selecting different challenge types for an elevated security challenge. Indeed, the security elevation system 106 generates and provides the elevated challenge interface 604 based on determining that a requested network event warrants additional client device interaction for authorization. Accordingly, the security elevation system 106 provides the elevated challenge interface 604 that includes options for different challenge types.

For instance, the security elevation system 106 utilizes a logic platform to determine that the security data for a requested network event allows for five different challenge types, and the security elevation system 106 thus generates selectable options for each of the five possible challenge types within the elevated challenge interface 604. In some cases, however, the security elevation system 106 may determine that a particular event request requires a particular challenge type (and/or is compatible with a smaller number of challenge types) because of its elevated risk (or other factors, such as the requesting user account, the transaction amount, or other security data considerations). In these or other cases, the security elevation system 106 generates the elevated challenge interface 604 to include fewer interface elements for selecting corresponding challenge types.

Based on selection of a challenge type from the elevated challenge interface 604, the security elevation system 106 queries a corresponding vendor network to determine whether the vendor network for the selected challenge type is available. If so, the security elevation system 106 generates and provides an elevated security challenge for display on the client device 602 as described above. If not, the security elevation system 106 selects a fallback vendor for the same challenge type and/or selects a fallback vendor for a fallback challenge type for generating the elevated security challenge. The security elevation system 106 can also (or alternatively) select a fallback vendor and/or a fallback challenge based on determining device capabilities and/or connectivity of the client device 602. For instance, the security elevation system 106 selects a less computationally-intensive or bandwidth-intensive security challenge if the client device 602 has poor processing/memory capacity and/or poor network connectivity. In some embodiments, the security elevation system 106 provides a modified version of the elevated challenge interface 604 indicating that the initial selection is unavailable and requesting an alternative challenge type selection. In other embodiments, the security elevation system 106 automatically selects a fallback vendor/challenge without further input from the client device 602.

The components of the security elevation system 106 can include software, hardware, or both. For example, the components of the security elevation system 106 can include one or more instructions stored on a computer-readable storage medium and executable by processors of one or more computing devices (e.g., the server device(s) 102, the client device(s) 118, the administrator device(s) 116, and/or the third-party processing server(s) 112). When executed by the one or more processors, the computer-executable instructions of the security elevation system 106 can cause a computing device to perform the methods described herein. Alternatively, the components of the security elevation system 106 can comprise hardware, such as a special purpose processing device to perform a certain function or group of functions. Additionally or alternatively, the components of the security elevation system 106 can include a combination of computer-executable instructions and hardware.

Furthermore, the components of the security elevation system 106 performing the functions described herein may, for example, be implemented as part of a stand-alone application, as a module of an application, as a plug-in for applications including content management applications, as a library function or functions that may be called by other applications, and/or as a cloud-computing model. Thus, the components of the security elevation system 106 may be implemented as part of a stand-alone application on a personal computing device or a mobile device. Alternatively or additionally, the components of the security elevation system 106 may be implemented in any application that allows creation and delivery of financial and/or marketing content to users, including, but not limited to, various applications.

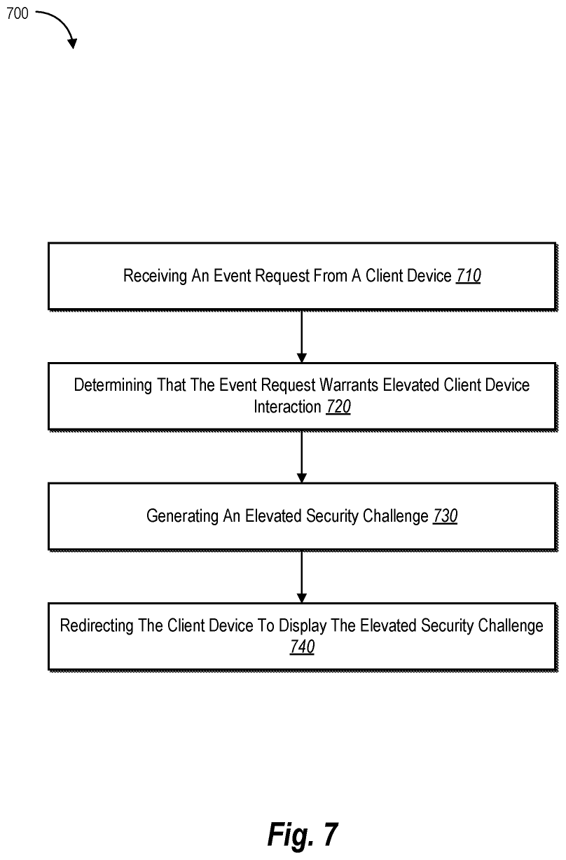

FIGS. 1-6, the corresponding text, and the examples provide a number of different systems, methods, and non-transitory computer readable media for generating and providing an elevated security challenge for performing network events. In addition to the foregoing, embodiments can also be described in terms of flowcharts comprising acts for accomplishing a particular result. For example, FIG. 7 illustrates a flowchart of an example sequence of acts in accordance with one or more embodiments.

While FIG. 7 illustrates acts according to some embodiments, alternative embodiments may omit, add to, reorder, and/or modify any of the acts shown in FIG. 7. The acts of FIG. 7 can be performed as part of a method. Alternatively, a non-transitory computer readable medium can comprise instructions, that when executed by one or more processors, cause a computing device to perform the acts of FIG. 7. In still further embodiments, a system can perform the acts of FIG. 7. Additionally, the acts described herein may be repeated or performed in parallel with one another or in parallel with different instances of the same or other similar acts.

FIG. 7 illustrates an example series of acts 700 for generating and providing an elevated security challenge for performing network events. The series of acts 700 can include acts 710-740. The act 710 can involve receiving an event request from a client device. Specifically, the act 710 can involve receiving, from a client device, an event request indicating a requested network event from among a plurality of network events hosted by an inter-network facilitation system. In addition, the act 720 can include determining that the event request warrants elevated client device interaction. For instance, the act 720 can involve determining, utilizing a logic platform of the inter-network facilitation system, that the event request warrants elevated client device interaction to maintain data security. Additionally, the act 730 includes generating an elevated security challenge. Specifically, the act 730 involves, based on determining that the event request warrants elevated client device interaction, generating, utilizing a security challenge platform of the inter-network facilitation system, an elevated security challenge that is adapted to security data associated with the event request. As shown, the act 740 includes redirected the client device to display the elevated security challenge. Particularly, the act 740 involves redirecting network communications of the client device to the security challenge platform to provide the elevated security challenge for display.

In some embodiments, the series of acts 700 includes determining that the event request warrants elevated client device interaction by utilizing the logic platform to determine a security category for the event request from among a plurality of security categories comprising an allow category, a deny category, and an elevate category. In these or other embodiments, the series of acts 700 involves generating the elevated security challenge by utilizing the security challenge platform to: determine a challenge type for the elevated security challenge based on data from the logic platform; detect that a vendor network associated with the challenge type is unavailable; and based on detecting that the vendor network is unavailable, select a fallback elevated security challenge for the event request.

In addition, the series of acts 700 can include generating the elevated security challenge by: detecting that the client device is incompatible with a first elevated security challenge for the event request; and based on detecting that the client device is incompatible with the first elevated security challenge, generating a second elevated security challenge for the event request based on capabilities of the client device. Further, the series of acts 700 can include providing the elevated security challenge for display by: redirecting network communications of the client device from an event workflow comprising a series of user interfaces associated with the event request to a security challenge workflow comprising one or more user interfaces associated with the elevated security challenge; and upon detecting completion of the security challenge workflow, returning network communications of the client device to the event workflow for the event request.

In one or more embodiments, the series of acts 700 includes determining that the event request warrants elevated client device interaction by: generating, using the logic platform, an encrypted logic string comprising event request data indicating a user account identification, a challenge type for the elevated security challenge, and an event identification for the event request; and decrypting the encrypted logic string using the security challenge platform to determine parameters for defining the elevated security challenge. The series of acts 700 can also include an act of detecting completion of the elevated security challenge via the client device and an act of, based on completion of the elevated security challenge, executing the requested network event associated with the event request.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system, including by one or more servers. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, virtual reality devices, personal computers, desktop computers, laptop computers, message processors, hand-held devices, multi-processor systems, microprocessor-based or programmable consumer electronics, network PCs, minicomputers, mainframe computers, mobile telephones, PDAS, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 8 illustrates, in block diagram form, an exemplary computing device 800 (e.g., the client device(s) 118, the administrator device(s) 116, or the server device(s) 102) that may be configured to perform one or more of the processes described above. As shown by FIG. 8, the computing device can comprise a processor 802, memory 804, a storage device 806, an I/O interface 808, and a communication interface 810. In certain embodiments, the computing device 800 can include fewer or more components than those shown in FIG. 8. Components of computing device 800 shown in FIG. 8 will now be described in additional detail.

In particular embodiments, processor(s) 802 includes hardware for executing instructions, such as those making up a computer program. As an example, and not by way of limitation, to execute instructions, processor(s) 802 may retrieve (or fetch) the instructions from an internal register, an internal cache, memory 804, or a storage device 806 and decode and execute them.

The computing device 800 includes memory 804, which is coupled to the processor(s) 802. The memory 804 may be used for storing data, metadata, and programs for execution by the processor(s). The memory 804 may include one or more of volatile and non-volatile memories, such as Random Access Memory (“RAM”), Read Only Memory (“ROM”), a solid-state disk (“SSD”), Flash, Phase Change Memory (“PCM”), or other types of data storage. The memory 804 may be internal or distributed memory.

The computing device 800 includes a storage device 806 includes storage for storing data or instructions. As an example, and not by way of limitation, storage device 806 can comprise a non-transitory storage medium described above. The storage device 806 may include a hard disk drive (“HDD”), flash memory, a Universal Serial Bus (“USB”) drive or a combination of these or other storage devices.

The computing device 800 also includes one or more input or output interface 808 (or “I/O interface 808”), which are provided to allow a user (e.g., requester or provider) to provide input to (such as user strokes), receive output from, and otherwise transfer data to and from the computing device 800. These I/O interface 808 may include a mouse, keypad or a keyboard, a touch screen, camera, optical scanner, network interface, modem, other known I/O devices or a combination of such I/O interface 808. The touch screen may be activated with a stylus or a finger.

The I/O interface 808 may include one or more devices for presenting output to a user, including, but not limited to, a graphics engine, a display (e.g., a display screen), one or more output providers (e.g., display providers), one or more audio speakers, and one or more audio providers. In certain embodiments, interface 808 is configured to provide graphical data to a display for presentation to a user. The graphical data may be representative of one or more graphical user interfaces and/or any other graphical content as may serve a particular implementation.

The computing device 800 can further include a communication interface 810. The communication interface 810 can include hardware, software, or both. The communication interface 810 can provide one or more interfaces for communication (such as, for example, packet-based communication) between the computing device and one or more other computing devices 800 or one or more networks. As an example, and not by way of limitation, communication interface 810 may include a network interface controller (“NIC”) or network adapter for communicating with an Ethernet or other wire-based network or a wireless NIC (“WNIC”) or wireless adapter for communicating with a wireless network, such as a WI-FI. The computing device 800 can further include a bus 812. The bus 812 can comprise hardware, software, or both that connects components of computing device 800 to each other.

FIG. 9 illustrates an example network environment 900 of the inter-network facilitation system 104. The network environment 900 includes a client device 906 (e.g., the client device 118 and/or administrator device(s) 116), an inter-network facilitation system 104, and a third-party system 909 (e.g., the third-party processing server(s) 112) connected to each other by a network 904. Although FIG. 9 illustrates a particular arrangement of the client device 906, the inter-network facilitation system 104, the third-party system 909, and the network 904, this disclosure contemplates any suitable arrangement of client device 906, the inter-network facilitation system 104, the third-party system 909, and the network 904. As an example, and not by way of limitation, two or more of client device 906, the inter-network facilitation system 104, and the third-party system 909 communicate directly, bypassing network 904. As another example, two or more of client device 906, the inter-network facilitation system 104, and the third-party system 909 may be physically or logically co-located with each other in whole or in part.

Moreover, although FIG. 9 illustrates a particular number of client devices 906, inter-network facilitation systems 104, third-party systems 909, and networks 904, this disclosure contemplates any suitable number of client devices 906, inter-network facilitation system 104, third-party systems 909, and networks 904. As an example, and not by way of limitation, network environment 900 may include multiple client devices 906, inter-network facilitation system 104, third-party systems 909, and/or networks 904.

This disclosure contemplates any suitable network 904. As an example, and not by way of limitation, one or more portions of network 904 may include an ad hoc network, an intranet, an extranet, a virtual private network (“VPN”), a local area network (“LAN”), a wireless LAN (“WLAN”), a wide area network (“WAN”), a wireless WAN (“WWAN”), a metropolitan area network (“MAN”), a portion of the Internet, a portion of the Public Switched Telephone Network (“PSTN”), a cellular telephone network, or a combination of two or more of these. Network 904 may include one or more networks 904.

Links may connect client device 906, the inter-network facilitation system 104 (which hosts the security elevation system 106), and third-party system 909 to network 904 or to each other. This disclosure contemplates any suitable links. In particular embodiments, one or more links include one or more wireline (such as for example Digital Subscriber Line (“DSL”) or Data Over Cable Service Interface Specification (“DOCSIS”), wireless (such as for example Wi-Fi or Worldwide Interoperability for Microwave Access (“WiMAX”), or optical (such as for example Synchronous Optical Network (“SONET”) or Synchronous Digital Hierarchy (“SDH”) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 900. One or more first links may differ in one or more respects from one or more second links.

In particular embodiments, the client device 906 may be an electronic device including hardware, software, or embedded logic components or a combination of two or more such components and capable of carrying out the appropriate functionalities implemented or supported by client device 906. As an example, and not by way of limitation, a client device 906 may include any of the computing devices discussed above in relation to FIG. 8. A client device 906 may enable a network user at the client device 906 to access network 904. A client device 906 may enable its user to communicate with other users at other client devices 906.

In particular embodiments, the client device 906 may include a requester application or a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at the client device 906 may enter a Uniform Resource Locator (“URL”) or other address directing the web browser to a particular server (such as server), and the web browser may generate a Hyper Text Transfer Protocol (“HTTP”) request and communicate the HTTP request to server. The server may accept the HTTP request and communicate to the client device 906 one or more Hyper Text Markup Language (“HTML”) files responsive to the HTTP request. The client device 906 may render a webpage based on the HTML files from the server for presentation to the user. This disclosure contemplates any suitable webpage files. As an example, and not by way of limitation, webpages may render from HTML files, Extensible Hyper Text Markup Language (“XHTML”) files, or Extensible Markup Language (“XML”) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, inter-network facilitation system 104 may be a network-addressable computing system that can interface between two or more computing networks or servers associated with different entities such as financial institutions (e.g., banks, credit processing systems, ATM systems, or others). In particular, the inter-network facilitation system 104 can send and receive network communications (e.g., via the network 904) to link the third-party system 909. For example, the inter-network facilitation system 104 may receive authentication credentials from a user to link a third-party system 909 such as an online banking system to link an online bank account, credit account, debit account, or other financial account to a user profile within the inter-network facilitation system 104. The inter-network facilitation system 104 can subsequently communicate with the third-party system 909 to detect or identify balances, transactions, withdrawal, transfers, deposits, credits, debits, or other transaction types associated with the third-party system 909. The inter-network facilitation system 104 can further provide the aforementioned or other financial information associated with the third-party system 909 for display via the client device 906. In some cases, the inter-network facilitation system 104 links more than one third-party system 909, receiving account information for accounts associated with each respective third-party system 909 and performing operations or transactions between the different systems via authorized network connections.

In particular embodiments, the inter-network facilitation system 104 may interface between an online banking system and a credit processing system via the network 904. For example, the inter-network facilitation system 104 can provide access to a bank account of a third-party system 909 and linked to a user profile within the inter-network facilitation system 104. Indeed, the inter-network facilitation system 104 can facilitate access to, and transactions to and from, the bank account of the third-party system 909 via a client application of the inter-network facilitation system 104 on the client device 906. The inter-network facilitation system 104 can also communicate with a credit processing system, an ATM system, and/or other financial systems (e.g., via the network 904) to authorize and process credit charges to a credit account, perform ATM transactions, perform transfers (or other transactions) between user profiles or across accounts of different third-party systems 909, and to present corresponding information via the client device 906.

In particular embodiments, the inter-network facilitation system 104 includes a model (e.g., a machine learning model) for approving or denying transactions. For example, the inter-network facilitation system 104 includes a transaction approval machine learning model that is trained based on training data such as user profile information (e.g., name, age, location, and/or income), account information (e.g., current balance, average balance, maximum balance, and/or minimum balance), credit usage, and/or other transaction history. Based on one or more of these data (from the inter-network facilitation system 104 and/or one or more third-party systems 909), the inter-network facilitation system 104 can utilize the transaction approval machine learning model to generate a prediction (e.g., a percentage likelihood) of approval or denial of a transaction (e.g., a withdrawal, a transfer, or a purchase) across one or more networked systems.

The inter-network facilitation system 104 may be accessed by the other components of network environment 900 either directly or via network 904. In particular embodiments, the inter-network facilitation system 104 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by server. In particular embodiments, the inter-network facilitation system 104 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable a client device 906, or an inter-network facilitation system 104 to manage, retrieve, modify, add, or delete, the information stored in data store.

In particular embodiments, the inter-network facilitation system 104 may provide users with the ability to take actions on various types of items or objects, supported by the inter-network facilitation system 104. As an example, and not by way of limitation, the items and objects may include financial institution networks for banking, credit processing, or other transactions, to which users of the inter-network facilitation system 104 may belong, computer-based applications that a user may use, transactions, interactions that a user may perform, or other suitable items or objects. A user may interact with anything that is capable of being represented in the inter-network facilitation system 104 or by an external system of a third-party system, which is separate from inter-network facilitation system 104 and coupled to the inter-network facilitation system 104 via a network 904.

In particular embodiments, the inter-network facilitation system 104 may be capable of linking a variety of entities. As an example, and not by way of limitation, the inter-network facilitation system 104 may enable users to interact with each other or other entities, or to allow users to interact with these entities through an application programming interfaces (“API”) or other communication channels.

In particular embodiments, the inter-network facilitation system 104 may include a variety of servers, sub-systems, programs, modules, logs, and data stores. In particular embodiments, the inter-network facilitation system 104 may include one or more of the following: a web server, action logger, API-request server, transaction engine, cross-institution network interface manager, notification controller, action log, third-party-content-object-exposure log, inference module, authorization/privacy server, search module, user-interface module, user-profile (e.g., provider profile or requester profile) store, connection store, third-party content store, or location store. The inter-network facilitation system 104 may also include suitable components such as network interfaces, security mechanisms, load balancers, failover servers, management-and-network-operations consoles, other suitable components, or any suitable combination thereof. In particular embodiments, the inter-network facilitation system 104 may include one or more user-profile stores for storing user profiles and/or account information for credit accounts, secured accounts, secondary accounts, and other affiliated financial networking system accounts. A user profile may include, for example, biographic information, demographic information, financial information, behavioral information, social information, or other types of descriptive information, such as interests, affinities, or location.

The web server may include a mail server or other messaging functionality for receiving and routing messages between the inter-network facilitation system 104 and one or more client devices 906. An action logger may be used to receive communications from a web server about a user's actions on or off the inter-network facilitation system 104. In conjunction with the action log, a third-party-content-object log may be maintained of user exposures to third-party-content objects. A notification controller may provide information regarding content objects to a client device 906. Information may be pushed to a client device 906 as notifications, or information may be pulled from client device 906 responsive to a request received from client device 906. Authorization servers may be used to enforce one or more privacy settings of the users of the inter-network facilitation system 104. A privacy setting of a user determines how particular information associated with a user can be shared. The authorization server may allow users to opt in to or opt out of having their actions logged by the inter-network facilitation system 104 or shared with other systems, such as, for example, by setting appropriate privacy settings. Third-party-content-object stores may be used to store content objects received from third parties. Location stores may be used for storing location information received from client devices 906 associated with users.

In addition, the third-party system 909 can include one or more computing devices, servers, or sub-networks associated with internet banks, central banks, commercial banks, retail banks, credit processors, credit issuers, ATM systems, credit unions, loan associates, brokerage firms, linked to the inter-network facilitation system 104 via the network 904. A third-party system 909 can communicate with the inter-network facilitation system 104 to provide financial information pertaining to balances, transactions, and other information, whereupon the inter-network facilitation system 104 can provide corresponding information for display via the client device 906. In particular embodiments, a third-party system 909 communicates with the inter-network facilitation system 104 to update account balances, transaction histories, credit usage, and other internal information of the inter-network facilitation system 104 and/or the third-party system 909 based on user interaction with the inter-network facilitation system 104 (e.g., via the client device 906). Indeed, the inter-network facilitation system 104 can synchronize information across one or more third-party systems 909 to reflect accurate account information (e.g., balances, transactions, etc.) across one or more networked systems, including instances where a transaction (e.g., a transfer) from one third-party system 909 affects another third-party system 909.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A method comprising:
receiving, from a client device, an event request indicating a requested network event from among a plurality of network events hosted by an inter-network facilitation system;
determining, utilizing a logic platform of the inter-network facilitation system, that the event request warrants elevated client device interaction to maintain data security;
based on determining that the event request warrants elevated client device interaction, generating, utilizing a security challenge platform of the inter-network facilitation system, an elevated security challenge that is adapted to security data associated with the event request; and
redirecting network communications of the client device to the security challenge platform to provide the elevated security challenge for display.

2. The method of claim 1, wherein determining that the event request warrants elevated client device interaction comprises utilizing the logic platform to determine a security category for the event request from among a plurality of security categories comprising an allow category, a deny category, and an elevate category.

3. The method of claim 1, wherein generating the elevated security challenge comprises utilizing the security challenge platform to:
determine a challenge type for the elevated security challenge based on data from the logic platform;
detect that a vendor network associated with the challenge type is unavailable; and
based on detecting that the vendor network is unavailable, select a fallback elevated security challenge for the event request.

4. The method of claim 1, wherein generating the elevated security challenge comprises:
detecting that the client device is incompatible with a first elevated security challenge for the event request; and
based on detecting that the client device is incompatible with the first elevated security challenge, generating a second elevated security challenge for the event request based on capabilities of the client device.

5. The method of claim 1, wherein providing the elevated security challenge for display comprises:
redirecting network communications of the client device from an event workflow comprising a series of user interfaces associated with the event request to a security challenge workflow comprising one or more user interfaces associated with the elevated security challenge; and
upon detecting completion of the security challenge workflow, returning network communications of the client device to the event workflow for the event request.

6. The method of claim 1, wherein determining that the event request warrants elevated client device interaction comprises:
generating, using the logic platform, an encrypted logic string comprising event request data indicating a user account identification, a challenge type for the elevated security challenge, and an event identification for the event request; and
decrypting the encrypted logic string using the security challenge platform to determine parameters for defining the elevated security challenge.

7. The method of claim 1, further comprising:
detecting completion of the elevated security challenge via the client device; and
based on completion of the elevated security challenge, executing the requested network event associated with the event request.

8. A system comprising:
at least one processor; and
a non-transitory computer readable medium storing instructions that, when executed by the at least one processor, cause the system to:
receive, from a client device, an event request indicating a requested network event from among a plurality of network events hosted by an inter-network facilitation system;
determine, utilizing a logic platform of the inter-network facilitation system, that the event request warrants elevated client device interaction to maintain data security;
based on determining that the event request warrants elevated client device interaction, generate, utilizing a security challenge platform of the inter-network facilitation system, an elevated security challenge that is adapted to security data associated with the event request; and
redirect network communications of the client device to the security challenge platform to provide the elevated security challenge for display.

9. The system of claim 8, further storing instructions that, when executed by the at least one processor, cause the system to determine that the event request warrants elevated client device interaction by utilizing the logic platform to determine a security category for the event request from among a plurality of security categories comprising an allow category, a deny category, and an elevate category.

10. The system of claim 8, further storing instructions that, when executed by the at least one processor, cause the system to generate the elevated security challenge by utilizing the security challenge platform to:
determine a challenge type for the elevated security challenge based on data from the logic platform;
detect that a vendor network associated with the challenge type is unavailable; and
based on detecting that the vendor network is unavailable, select a fallback elevated security challenge for the event request.

11. The system of claim 8, further storing instructions that, when executed by the at least one processor, cause the system to generate the elevated security challenge by:
detecting that the client device is incompatible with a first elevated security challenge for the event request; and
based on detecting that the client device is incompatible with the first elevated security challenge, generating a second elevated security challenge for the event request based on capabilities of the client device.

12. The system of claim 8, further storing instructions that, when executed by the at least one processor, cause the system to provide the elevated security challenge for display by:
redirecting network communications of the client device from an event workflow comprising a series of user interfaces associated with the event request to a security challenge workflow comprising one or more user interfaces associated with the elevated security challenge; and
upon detecting completion of the security challenge workflow, returning network communications of the client device to the event workflow for the event request.

13. The system of claim 8, further storing instructions that, when executed by the at least one processor, cause the system to determine that the event request warrants elevated client device interaction by:
generating, using the logic platform, an encrypted logic string comprising event request data indicating a user account identification, a challenge type for the elevated security challenge, and an event identification for the event request; and
decrypting the encrypted logic string using the security challenge platform to determine parameters for defining the elevated security challenge.

14. The system of claim 8, further storing instructions that, when executed by the at least one processor, cause the system to:
detect completion of the elevated security challenge via the client device; and
based on completion of the elevated security challenge, execute the requested network event associated with the event request.

15. A non-transitory computer readable medium storing instructions that, when executed by at least one processor, cause a computing device to:
receive, from a client device, an event request indicating a requested network event from among a plurality of network events hosted by an inter-network facilitation system;
determine, utilizing a logic platform of the inter-network facilitation system, that the event request warrants elevated client device interaction to maintain data security;
based on determining that the event request warrants elevated client device interaction, generate, utilizing a security challenge platform of the inter-network facilitation system, an elevated security challenge that is adapted to security data associated with the event request; and
redirect network communications of the client device to the security challenge platform to provide the elevated security challenge for display.

16. The non-transitory computer readable medium of claim 15, further storing instructions that, when executed by the at least one processor, cause the computing device to determine that the event request warrants elevated client device interaction by utilizing the logic platform to determine a security category for the event request from among a plurality of security categories comprising an allow category, a deny category, and an elevate category.

17. The non-transitory computer readable medium of claim 15, further storing instructions that, when executed by the at least one processor, cause the computing device to generate the elevated security challenge by utilizing the security challenge platform to:
determine a challenge type for the elevated security challenge based on data from the logic platform;
detect that a vendor network associated with the challenge type is unavailable; and
based on detecting that the vendor network is unavailable, select a fallback elevated security challenge for the event request.

18. The non-transitory computer readable medium of claim 15, further storing instructions that, when executed by the at least one processor, cause the computing device to generating the elevated security challenge by:
detecting that the client device is incompatible with a first elevated security challenge for the event request; and
based on detecting that the client device is incompatible with the first elevated security challenge, generating a second elevated security challenge for the event request based on capabilities of the client device.

19. The non-transitory computer readable medium of claim 15, further storing instructions that, when executed by the at least one processor, cause the computing device to provide the elevated security challenge for display by:
redirecting network communications of the client device from an event workflow comprising a series of user interfaces associated with the event request to a security challenge workflow comprising one or more user interfaces associated with the elevated security challenge; and
upon detecting completion of the security challenge workflow, returning network communications of the client device to the event workflow for the event request.

20. The non-transitory computer readable medium of claim 15, further storing instructions that, when executed by the at least one processor, cause the computing device to determine that the event request warrants elevated client device interaction by:
generating, using the logic platform, an encrypted logic string comprising event request data indicating a user account identification, a challenge type for the elevated security challenge, and an event identification for the event request; and
decrypting the encrypted logic string using the security challenge platform to determine parameters for defining the elevated security challenge.
